(19) United States
(12) Patent Application Publication
(10) Pub. No.: US 2025/0224238 A1
(43) Pub. Date: Jul. 10, 2025

(54) TRAVELING ROUTE ESTIMATION APPARATUS

(71) Applicant: Honda Motor Co., Ltd., Tokyo (JP)

(72) Inventor: Yoshimitsu Murahashi, Wako-shi, Saitama (JP)

(21) Appl. No.: 18/852,834

(22) PCT Filed: Mar. 30, 2022
(86) PCT No.: PCT/JP2022/015931

§ 371 Date: Sep. 30, 2024

(51) Int. Cl. G01C 21/32; B60W 60/00

(52) U.S. Cl. CPC G01C 21/32; B60W 60/001

(57) ABSTRACT

A traveling route estimation apparatus includes: an external situation detection unit mounted on a vehicle and configured to detect an external situation around the vehicle; a traveling state detection unit configured to detect a traveling state of the vehicle; and a controller including a processor and a memory coupled to the processor. The controller is configured to perform: storing map information; estimating a traveling route on which the vehicle should travel at a predetermined cycle based on the external situation detected by the external situation detection unit; identifying a path on which the vehicle has actually traveled based on the traveling state detected by the traveling state detection unit; determining whether the traveling route matches the path; and storing a determination result in association with the map information.

### CROSS-REFERENCE TO RELATED APPLICATION

This application is a National Stage of PCT international application Ser. No. PCT/JP2022/015931 filed on Mar. 30, 2022 which designates the United States, incorporated herein by reference.

### TECHNICAL FIELD

The present invention relates to a traveling route estimation apparatus that estimates a traveling route on which a vehicle having an automatic driving function and a driving assistance function should travel.

### BACKGROUND ART

Conventionally, a device configured to automatically drive a vehicle has been known (see, for example, Patent Literature 1). In the device described in Patent Literature 1, three-dimensional point cloud data acquired during traveling is collated with a previously established three-dimensional point cloud map including information on roads and the like, and three-dimensional point cloud data of a static object such as a road is acquired from three-dimensional image data generated by fusing the two-dimensional image data and the three-dimensional point cloud data acquired during traveling.

Vehicles having an automatic driving function and a driving assistance function are widely used, thus safety and convenience of the entire transportation society are improved, and a sustainable transportation system is achievable. In addition, since the efficiency and smoothness of transportation are improved, the CO₂ emission amount is reduced, and the load on environment can be reduced.

### CITATION LIST

### Patent Literature

Patent Literature 1: Japanese Unexamined Patent Publication No. 2020-85886

### SUMMARY OF INVENTION

### Technical Problem

Although it is preferable that automatic driving and driving assistance of a vehicle can be continued even in an area having no map information established in advance, it is difficult to continue automatic driving and driving assistance in such an area in a case where map information established in advance is used as in the device described in Patent Literature 1.

### Solution to Problem

An aspect of the present invention is a traveling route estimation apparatus, including: an external situation detection unit mounted on a vehicle and configured to detect an external situation around the vehicle; a traveling state detection unit configured to detect a traveling state of the vehicle; and a controller. The controller is configured to perform: storing map information; estimating a traveling route on which the vehicle should travel at a predetermined cycle based on the external situation detected by the external situation detection unit; identifying a path on which the vehicle has actually traveled based on the traveling state detected by the traveling state detection unit; determining whether the traveling route matches the path; and storing a determination result in association with the map information.

### Advantageous Effects of the Invention

According to the present invention, it becomes possible to enhance continuity of automatic driving and driving assistance of the vehicle even in an area without map information established in advance.

### BRIEF DESCRIPTION OF DRAWINGS

FIG. 1 A block diagram schematically illustrating a configuration of a traveling route estimation apparatus according to an embodiment of the present invention

FIG. 2A A diagram illustrating an example of a traveling route of a case where the estimated traveling route matches an actual path

FIG. 2B A diagram illustrating an example of the path of the case where the estimated traveling route matches the actual path

FIG. 3A A diagram illustrating an example of the traveling route of a case where the estimated traveling route does not match the actual path

FIG. 3B A diagram illustrating an example of the path of the case where the estimated traveling route does not match the actual path

FIG. 4 A diagram illustrating an example of a determination result stored in association with map information

FIG. 5 A diagram for explaining whether or not automatic driving and driving assistance based on the determination result can be performed

FIG. 6A A diagram for explaining exclusion of traveling routes estimated at specific time points

FIG. 6B A diagram for explaining generation of a traveling route map

FIG. 7 A diagram for explaining calculation of reliability based on the determination result

### DESCRIPTION OF EMBODIMENT

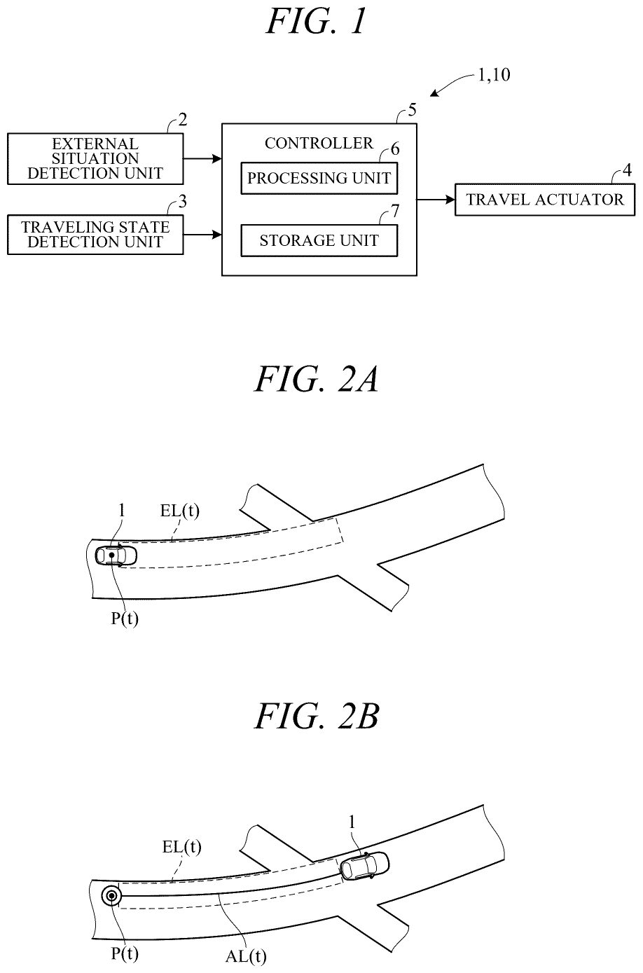

Hereinafter, an embodiment of the present invention will be described with reference to FIGS. 1 to 7. A traveling route estimation apparatus according to the embodiment of the present invention is applied to a vehicle having a driving assistance function of controlling a travel actuator to perform driving assistance for a driver of the vehicle or to automatically drive the vehicle, and estimates a traveling route on which the vehicle should travel. The “driving assistance” in the present embodiment includes driving assistance for assisting a driver's driving operation and automatic driving for automatically driving the vehicle regardless of the driver's driving operation, and corresponds to automatic driving of levels 1 to 4 defined by SAE, and the “automatic driving” corresponds to automatic driving of level 5.

In automatic driving and driving assistance, steering assistance that assists steering has a large effect of reducing a burden on a driver. Therefore, it is required to continue assistance not only on an expressway or the like on which a lane marking defining a traveling lane is provided, but also on an intersection of ordinary roads on which no lane marking is provided. However, a high precision map used for automatic driving and driving assistance is created in an area with a large traffic volume such as an expressway or an urban area, but is not created in an area with a small traffic volume such as a residential area or a suburb. In addition, the road structure may change due to construction or the like after the latest high precision map is created.

Therefore, in order to enhance the continuity of automatic driving and driving assistance even in an area where a high precision map established in advance is not created, it is necessary to estimate a traveling route on which each vehicle should travel by independently using an in-vehicle sensor or the like on the vehicle side when each vehicle travels. Therefore, in the present embodiment, the traveling route estimation apparatus is configured as follows so as to be able to enhance the continuity of automatic driving and driving assistance of the vehicle even in an area without map information established in advance by estimating a traveling route on which the vehicle should travel using an in-vehicle sensor or the like.

FIG. 1 is a block diagram schematically illustrating a configuration of a traveling route estimation apparatus 10 according to an embodiment of the present invention. As illustrated in FIG. 1, the traveling route estimation apparatus 10 includes an external situation detection unit 2 mounted on a vehicle 1, a traveling state detection unit 3, a travel actuator 4, and a controller 5. The external situation detection unit 2, the traveling state detection unit 3, and the travel actuator 4 are connected to the controller 5.

The external situation detection unit 2 is mounted on the vehicle 1, and detects an external situation around the vehicle 1, particularly in front of the vehicle 1. The external situation detection unit 2 includes, for example, a camera that includes an imaging element such as a CCD or a CMOS and images the surroundings of the vehicle 1. The external situation detection unit 2 may include a millimeter wave radar that emits a millimeter wave (radio wave) and measures a distance and a direction to an object from a time until the emitted wave hits the object and returns. The external situation detection unit 2 may include a LiDAR that emits laser light and measures a distance and a direction to an object from a time until the emitted light hits the object and returns.

On the basis of the external situation detected by the external situation detection unit 2, it is possible to recognize a road surface on which the vehicle can travel, a traveling lane defined by a lane marking or a structure, obstacles on a road including traffic participants such as surrounding vehicles and pedestrians, and the like, and to estimate a traveling route EL on which the vehicle 1 should travel. More specifically, it is possible to estimate a traveling route EL (t) from a current position P (t) of the vehicle 1 at a predetermined time point t to at least a predetermined distance ahead detectable by the external situation detection unit 2.

The traveling state detection unit 3 detects a traveling state such as a traveling speed and an advancing direction of the vehicle 1. For example, the traveling state detection unit 3 includes an inertial measurement unit (IMU) that detects rotational angular velocity around three axes in the vertical direction at the center of gravity of the vehicle 1, the advancing direction of the vehicle 1, and the vehicle-width direction of the vehicle 1, and accelerations in the directions of three axes. The traveling state detection unit 3 may include a wheel speed sensor that detects a rotation speed of each wheel of the vehicle 1. The traveling state detection unit 3 may include a positioning unit or the like that measures the current position (latitude and longitude) of the vehicle 1, on the basis of a positioning signal from a positioning satellite.

On the basis of the traveling state detected by the traveling state detection unit 3, it is possible to calculate the amount of movement of the vehicle 1 at every predetermined time and to identify the path AL on which the vehicle 1 has traveled. For example, it is possible to identify the actual path AL (t) on which the vehicle 1 has traveled from the predetermined time point t at which the traveling route EL of the vehicle 1 was estimated to the current time point. The actual path AL on which the vehicle 1 has traveled may be identified by connecting vehicle positions at predetermined time intervals.

The travel actuator 4 includes a steering mechanism such as a steering gear that steers the vehicle 1, a driving mechanism such as an engine or a motor that drives the vehicle 1, and a braking mechanism such as a brake that applies the brakes on the vehicle 1.

The controller 5 includes a computer including a processing unit 6 such as a CPU, a storage unit 7 such as a RAM and a ROM, an I/O interface, and other peripheral circuits. The controller 5 is configured as a part of a plurality of electronic control unit (ECU) groups that is mounted on, for example, the vehicle 1 and controls the operation of the vehicle 1. The storage unit 7 of the controller 5 stores in advance general map information used for route guidance from the current location of the vehicle 1 to the destination by a navigation device. The storage unit 7 also stores a high precision map for automatic driving.

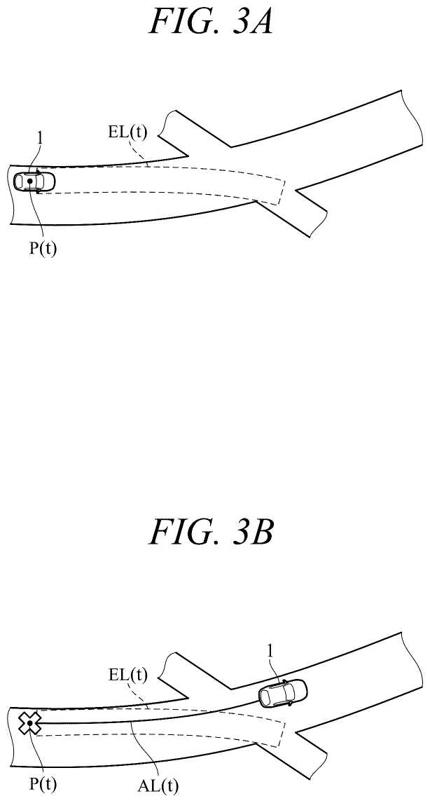

FIGS. 2A and 2B are diagrams illustrating an example of a case where the traveling route EL (t) estimated at the predetermined time point t matches the actual path AL (t), and FIGS. 3A and 3B are diagrams illustrating an example of a case where the traveling route EL (t) does not match the path AL (t).

As illustrated in FIGS. 2A and 3A, the processing unit 6 of the controller 5 estimates the traveling route EL on which the vehicle 1 should travel on the basis of the external situation detected by the external situation detection unit 2. More specifically, the traveling route EL (t) from the current position P (t) of the vehicle 1 at the predetermined time point t to a predetermined distance ahead is estimated. Such estimation of the traveling route EL is performed at a predetermined cycle (for example, a detection cycle of the external situation detection unit 2, a control cycle of the controller 5, a cycle of communication between the external situation detection unit 2 and the controller 5, or the like).

Information on the estimated traveling route EL (t) is stored in the storage unit 7 in association with the map information. More specifically, information on the estimated traveling route EL (t) is added to the map information in association with the position information of the current position P (t) of the vehicle 1 at the time point t when the traveling route EL (t) is estimated.

As illustrated in FIGS. 2B and 3B, the processing unit 6 of the controller 5 identifies the actual path AL when the vehicle 1 travels with the driver involved, on the basis of the traveling state detected by the traveling state detection unit 3, and determines whether or not the identified path AL matches the estimated traveling route EL. More specifically, the actual path AL (t) when the vehicle 1 travels with the driver involved in a section from the current position P (t) of the vehicle 1 at the time point t when the traveling route EL (t) was estimated to a predetermined distance ahead is identified, and it is determined whether or not the actual path AL (t) is within the range of the estimated traveling route EL (t).

Note that travel with the driver involved includes travel in a case where the driver manually drives without driving assistance and travel in a case where the driver manually drives with driving assistance.

As illustrated in FIG. 2B, when the actual path AL (t) when the vehicle 1 travels with the driver involved is within the range of the estimated traveling route EL (t), it is determined that the estimated traveling route EL (t) matches the identified path AL (t). Alternatively, it is determined that the traveling route estimation was appropriate.

In contrast, as illustrated in FIG. 3B, when the actual path AL (t) when the vehicle 1 travels with the driver involved is not within the range of the estimated traveling route EL (t), it is determined that the estimated traveling route EL (t) does not match the identified path AL (t). As described above, in a case where the estimated traveling route EL does not match the path AL when the vehicle I actually travels with the driver involved, it is highly likely that the traveling route estimation has not been appropriate. Therefore, this case is treated as a weak scene in traveling route estimation by the external situation detection unit 2.

Such a determination result is stored in the storage unit 7 in association with the map information together with the information on the estimated traveling route EL (t). More specifically, such a determination result is associated with the position information of the current position P (t) of the vehicle 1 at the time point t when the traveling route EL (t) was estimated and is added to the map information together with the information on the estimated traveling route EL (t).

In a case where the estimated traveling route EL does not match the path AL when the vehicle I actually travels with the driver involved, the detection result by the external situation detection unit 2 at the time point t when such a traveling route EL (t) was estimated or before and after the time point t may be transmitted to an external analysis device or the like. In this case, it is possible to efficiently collect only data of weak scenes in traveling route estimation by the external situation detection unit 2 from a large number of vehicles 1 and to analyze a factor that makes traveling route estimation inappropriate.

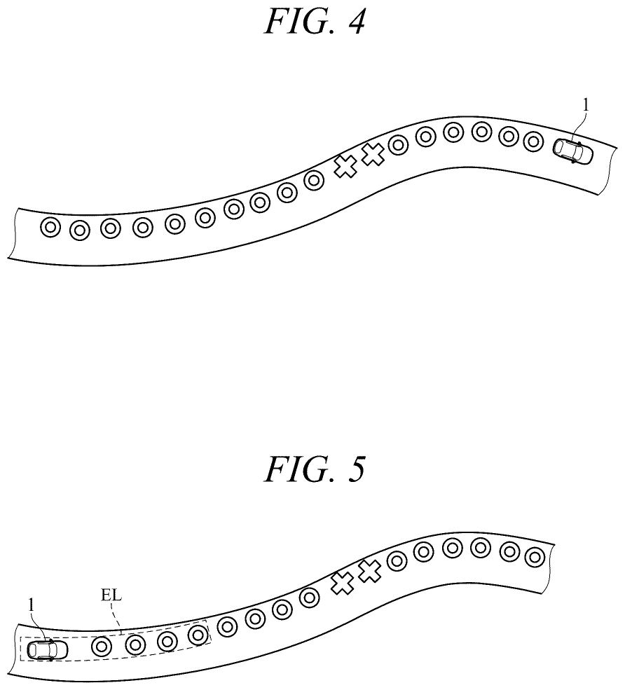

FIG. 4 is a diagram illustrating an example of a determination result stored in association with map information. As illustrated in FIG. 4, information on a determination result as to whether or not it is a weak scene in traveling route estimation by the external situation detection unit 2, corresponding to the vehicle position at each predetermined cycle in the area where the vehicle 1 has actually traveled with the driver involved is added to the map information stored in the storage unit 7 of the controller 5.

FIG. 5 is a diagram for explaining whether or not automatic driving and driving assistance based on the determination result can be performed, and illustrates a situation in which the vehicle 1 is traveling using automatic driving or driving assistance in an area where the vehicle 1 has traveled in the past with the driver involved.

As illustrated in FIG. 5, the processing unit 6 of the controller 5 estimates the traveling route EL on the basis of the external situation detected by the external situation detection unit 2, and determines whether to continue or interrupt automatic driving or driving assistance in use on the basis of the past determination result on the course of the vehicle 1. In other words, it is determined whether or not to permit control of the travel actuator 4 based on the traveling route EL estimated on the basis of the external situation detected by the external situation detection unit 2 at each point on the course.

More specifically, it is determined whether or not there is a point at which the traveling route EL was estimated in the past and which has been determined to be a weak scene within a predetermined section (for example, a section from the current position of the vehicle 1 to about 300 m ahead) on the course of the vehicle 1. In a case where there is a point determined to be a weak scene within the predetermined section, the driver is notified, and then automatic driving or driving assistance currently in use is interrupted. Interruption of automatic driving or driving assistance currently in use includes a level down from automatic driving to driving assistance and a level down of driving assistance.

For example, if steering assistance is performed on the basis of an inappropriate traveling route EL, an auxiliary steering torque in an inappropriate direction is applied to the steering wheel gripped by the driver, and the driver needs to correct the auxiliary steering torque, which is actually a burden on the driver. When a point where it is highly likely that an inappropriate traveling route EL is estimated approaches, it is possible to prevent an unnecessary burden from being given to the driver by notifying the driver before the point and then interrupting automatic driving or driving assistance. Note that the length of the predetermined section for determining whether automatic driving or driving assistance is possible may be changed according to the shape of the road on the course, the speed limit, and the like.

Since there is a limit to detection of the external situation by the external situation detection unit 2 due to factors such as the surrounding environment, it is difficult to always estimate an appropriate traveling route EL depending on a point. By registering such a point as a weak scene, it is possible to actively use traveling route estimation by the external situation detection unit 2 except for the weak scene. For example, in a case where the traveling route EL is recognized on the basis of the detection result by the external situation detection unit 2 by using a deep neural network (DNN), if a strict threshold is set such that only the traveling route EL is recognized, recognition of the traveling route EL itself cannot be performed depending on a point, and traveling route estimation cannot be used. It is possible to enhance the availability of traveling route estimation as the entire apparatus by setting a gentle threshold that allows recognition of a portion other than the traveling route EL depending on a point and registering a point where it is highly likely that inappropriate traveling route recognition is performed as a weak scene.

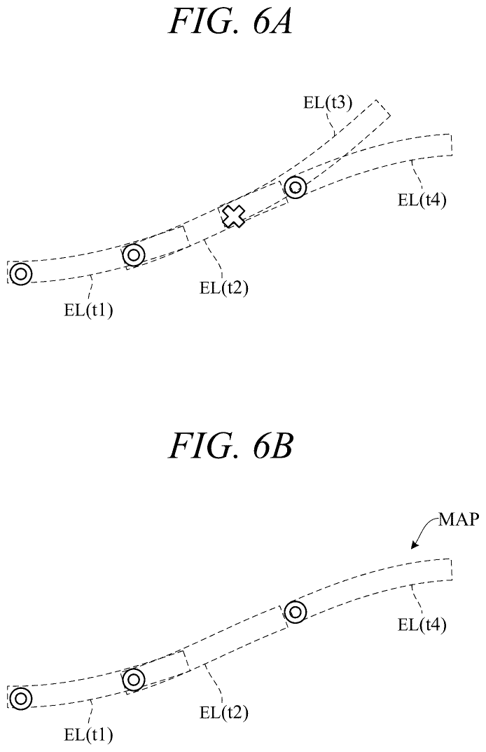

FIG. 6A is a diagram for explaining exclusion of traveling routes EL estimated at specific time points t1 to t4, and FIG. 6B is a diagram for explaining generation of a traveling route map MAP. As illustrated in FIGS. 6A and 6B, the processing unit 6 of the controller 5 determines whether or not to permit generation of the traveling route map MAP based on the estimated traveling route EL, on the basis of the determination result stored in the storage unit 7 in association with the map information.

More specifically, it is determined whether or not each point where the vehicle 1 has traveled in the past with the driver involved is a weak scene, and a traveling route EL estimated in other than the weak scene is permitted to be used for generating the traveling route map MAP, and a traveling route EL estimated in the weak scene is prohibited to be used. In the example of FIGS. 6A and 6B, a traveling route EL (t3) estimated at time point t3 at the point determined to be a weak scene is excluded, and the traveling route map MAP is generated on the basis of traveling routes EL (t1), EL (t2), and EL (t4) estimated at time points t1, t2, and t4 at the other points. The generated traveling route map MAP is stored in the storage unit 7 in association with the map information.

During automatic driving of the vehicle 1, consistency between the shape of the latest traveling route EL estimated as needed during traveling and the shape of the traveling route EL stored as the traveling route map MAP (or the high precision map) in the storage unit 7 is checked. The processing unit 6 of the controller 5 checks consistency in shape between the latest traveling route EL and the traveling route EL on the traveling route map MAP (or the high precision map), and then controls the travel actuator 4 so that the vehicle 1 travels on the estimated traveling route EL.

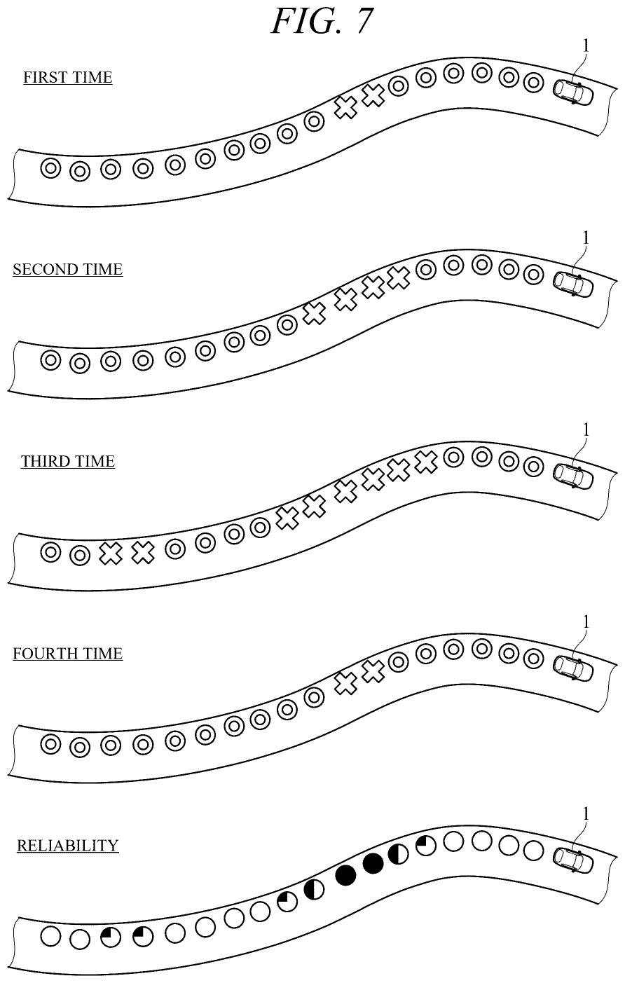

FIG. 7 is a diagram for explaining calculation of reliability based on the determination result, and illustrates an example of reliability calculated after traveling the same place a plurality of times (four times in FIG. 7). As illustrated in FIG. 7, the processing unit 6 of the controller 5 calculates reliability of the estimated traveling route EL on the basis of the determination result stored in association with the map information, and stores the calculated reliability in association with the map information.

Reliability can be calculated, for example, as a ratio of the actual number of times in which an appropriate traveling route EL has been estimated to the number of times of traveling in the past. In the example of FIG. 7, reliability of the point where an appropriate traveling route EL has been estimated four times out of the past four times is calculated as 100%, reliability of the point where an appropriate traveling route EL has been estimated three times is calculated as 75%, and reliability of the point where an appropriate traveling route EL has never been estimated is calculated as 0%.

In particular, in a case where automatic driving is performed, it is necessary to perform highly reliable traveling route estimation. By calculating reliability of traveling route estimation on the basis of the actual results when traveling is performed a plurality of times with the driver involved without automatic driving and using the result of traveling road estimation only in a case where the reliability exceeds an appropriate threshold, it is possible to perform appropriate automatic driving based on highly reliable traveling route estimation.

In addition, even in a case where it has been determined in the past that a travel scene is a weak scene for some reason, if the number of times of determination in which traveling route estimation is appropriate in a plurality of times of traveling increases, the traveling route EL can be used as a traveling route EL estimated in a highly reliable travel scene. As a result, it is possible to reduce a missing (interrupted) portion of the area where traveling route estimation can be used, and to enhance continuity of automatic driving and driving assistance.

According to the present embodiment, the following operations and effects can be achieved.

(1) The traveling route estimation apparatus 10 includes an external situation detection unit 2 that is mounted on the vehicle 1 and detects an external situation around the vehicle 1, the traveling state detection unit 3 that detects a traveling state of the vehicle 1, and the controller 5 (FIG. 1). The controller 5 stores map information, estimates a traveling route EL on which the vehicle 1 should travel at a predetermined cycle on the basis of the external situation detected by the external situation detection unit 2, identifies a path AL on which the vehicle 1 has actually traveled on the basis of the traveling state detected by the traveling state detection unit 3, determines whether or not the traveling route EL that has been estimated matches the path AL that has been identified, and stores a determination result in association with the map information (FIG. 4).

That is, in a case where the traveling route EL that has been estimated does not match the path AL when the vehicle 1 actually travels with a driver involved, the case is identifiably registered as a weak scene where it is highly likely that traveling route estimation by the external situation detection unit 2 is not appropriate. As a result, it is possible to actively use a traveling route EL estimated in a scene other than the weak scene, and it is possible to enhance continuity of automatic driving and driving assistance of the vehicle 1 even in an area without map information established in advance.

(2) The traveling route estimation apparatus 10 further includes the travel actuator 4 that is mounted on the vehicle 1 (FIG. 1). The controller 5 determines whether or not to permit control of the travel actuator 4 based on the traveling route EL that has been estimated on a course of the vehicle 1, on the basis of the determination result stored in association with the map information (FIG. 5). That is, a traveling route EL estimated in a scene other than the weak scene can be actively used in automatic driving or driving assistance, and continuity can be enhanced. In addition, in a case where there is a weak scene on the course, the driver is notified in advance, and automatic driving and driving assistance are interrupted, so that it is possible to avoid occurrence of inappropriate steering assistance and occurrence of the burden on the driver related to correction of the inappropriate steering assistance.

(3) The controller 5 determines whether or not to permit generation of a traveling route map MAP based on the traveling route EL that has been estimated, on the basis of the determination result stored in association with the map information (FIGS. 6A and 6B). That is, by excluding the traveling route EL estimated in the weak scene, an accurate traveling route map MAP can be generated. In addition, a traveling route EL estimated in a scene other than the weak scene can be actively used for generation of the traveling route map MAP, so that continuity of automatic driving and driving assistance can be enhanced.

(4) The controller 5 calculates reliability of the traveling route EL that has been estimated on the basis of the determination result stored in association with the map information, and stores the reliability that has been calculated in association with the map information (FIG. 7). That is, reliability of traveling route estimation in a travel scene is calculated on the basis of a plurality of determination results when the vehicle 1 travels in the same travel scene. As a result, for example, it is possible to use only the traveling route EL estimated in a highly reliable travel scene in which the number of times of determination in which traveling route estimation is appropriate is large. In addition, even in a case where it is determined that a travel scene is a weak scene under special circumstances, if the number of times of determination in which traveling route estimation is appropriate increases, the traveling route EL can be used as a traveling route EL estimated in a highly reliable travel scene, and continuity of automatic driving and driving assistance can be further enhanced.

The above description is only an example, and the present invention is not limited to the above embodiment and modifications, unless impairing features of the present invention. The above embodiment can be combined as desired with one or more of the above modifications. The modifications can also be combined with one another.

### Reference Signs List

1 vehicle, 2 external situation detection unit, 3 traveling state detection unit, 4 travel actuator, 5 controller, 6 processing unit, 7 storage unit, 10 traveling route estimation apparatus, AL actual path, EL traveling route, P current position

1. A traveling route estimation apparatus, comprising:
an external situation detection unit mounted on a vehicle and configured to detect an external situation around the vehicle;
a traveling state detection unit configured to detect a traveling state of the vehicle; and
a controller, wherein
the controller is configured to perform:
storing map information;
estimating a traveling route on which the vehicle should travel at a predetermined cycle based on the external situation detected by the external situation detection unit;
identifying a path on which the vehicle has actually traveled based on the traveling state detected by the traveling state detection unit;
determining whether the traveling route matches the path; and
storing a determination result in association with the map information.

2. The traveling route estimation apparatus according to claim 1, further comprising:
a travel actuator mounted on the vehicle, wherein
the controller determines whether to permit control of the travel actuator based on the traveling route on a course of the vehicle based on the determination result stored in association with the map information.

3. The traveling route estimation apparatus according to claim 1 or 2, wherein
the controller determines whether to permit generation of a traveling route map based on the traveling route, based on the determination result stored in association with the map information.

4. The traveling route estimation apparatus according to claim 1, wherein
the controller calculates reliability of the traveling route based on the determination result stored in association with the map information, and stores the reliability in association with the map information.
